(19) United States
(12) Patent Application Publication
(10) Pub. No.: US 2020/0183675 A1
(43) Pub. Date: Jun. 11, 2020

(54) IMAGE FILE PACKAGING METHOD AND IMAGE FILE PACKAGING SYSTEM

(71) Applicant: Wistron NeWeb Corp., Hsinchu (TW)

(72) Inventors: Hsin-Teng LIN, Hsinchu (TW); I-Hsun LIU, Hsinchu (TW); Wei-Chun HSU, Hsinchu (TW); Chih-Hung HUANG, Hsinchu (TW)

(21) Appl. No.: 16/573,361

(22) Filed: Sep. 17, 2019

(30) Foreign Application Priority Data
Dec. 6, 2018 (TW) 107143858

(51) Int. Cl. G06F 8/65; G06F 21/64; H04L 9/06

(52) U.S. Cl. CPC G06F 8/65; G06F 8/654; H04L 9/0643; G06F 21/64

(57) ABSTRACT

An image file packaging method is applied to a first device. The first device comprises a storage device and a first processor. The image file packaging method includes: the first device receives a kernel image wherein the initial kernel header is located in the kernel image; an initial application and the kernel image are stored in the storage device; and the first processor executes a hash tree generation program. The hash tree generation program performs the following steps: calculating an initial hash tree of the initial application to obtain an initial root node, and embedding the initial root node into the initial kernel header to generate a new version kernel header.

### CROSS-REFERENCE TO RELATED APPLICATION

This application claims priority of Taiwan Application Serial Number 107143858, filed on Dec. 6, 2018, the entirety of which is herein incorporated by reference.

### BACKGROUND

### Technical Field

The present invention relates to a package file mechanism, and in particular to an image file packaging method and image file packaging system.

### Description of the Related Art

In general, a contractor usually encrypts or signs system software or firmware by means of a system software or firmware protection verification algorithm when the client requires the contractor to implement the system software or firmware. This way, the protected system software or the protected firmware is used to protect the root file system memory partition (flash partition) and client application software storage block when running on the Linux kernel of the platform.

However, usually the client does not buy out the contractor's development within the kernel or the application design of the migration kit. Therefore, to protect the integrity of the client software block, the Linux kernel need to be recompiled every time the client releases a new version of the application software. After product development is completed, each software update must rely on the contractor's resources to recompile it. In addition, when the client's software is frequently new, the contractor must repackage the kernel image. The cost of maintenance is high due to the repeated updates and the packaging. If the source code in the kernel image is given to the client, there will be a trade secret leak because the rest of the kernel image contains the contractor's know-how.

Therefore, how to completely cut out the software development of the contractor and the software update of the client, while at the same time providing security protection for the image file, is a problem that needs to be solved.

### BRIEF SUMMARY

An embodiment of the invention introduces an image file packaging method. The image file packaging method is applied to a first device. The first device comprises a storage device and a first processor. The image file packaging method comprises: the first device receives a kernel image, wherein an initial kernel header is located in the kernel image; an initial application and the kernel image are stored in the storage device; and the first processor executes a hash tree generation program. The hash tree generation program performs the following steps: calculating the initial hash tree of the initial application to obtain an initial root node; and embedding the initial root node into the initial kernel header to generate a new version kernel header.

An embodiment of the invention introduces an image file packaging system. The image file packaging system comprises a first device. The first device is configured to receive a kernel image. An initial kernel header is located in the kernel image. The first device comprises a storage device and a first processor. The storage device is configured to store an initial application and the kernel image. The first processor is configured to execute a hash tree generation program. The hash tree generation program calculates an initial hash tree of the initial application to obtain an initial root node and embeds the initial root node into the initial kernel header to generate a new version kernel header.

### BRIEF DESCRIPTION OF THE DRAWINGS

The present invention can be fully understood by reading the subsequent detailed description and examples with references made to the accompanying drawings, wherein:

FIG. 1 is a block diagram illustrating an image file packaging system according to an embodiment of the invention;

FIG. 2 is a schematic diagram illustrating a verification hash tree according to an embodiment of the invention;

FIGS. 3A-3C are a schematic diagrams of image file packaging method according to an embodiment of the invention;

FIG. 4 is a schematic diagram illustrating a verification procedure according to an embodiment of the invention.

### DETAILED DESCRIPTION

The following description is of the best-contemplated mode of carrying out the invention. This description is made for the purpose of illustrating the general principles of the invention and should not be taken in a limiting sense. The scope of the invention is best determined by reference to the appended claims.

The present invention will be described with respect to particular embodiments and with reference to certain drawings, but the invention is not limited thereto and is only limited by the claims. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having the same name (but for use of the ordinal term) to distinguish the claim elements.

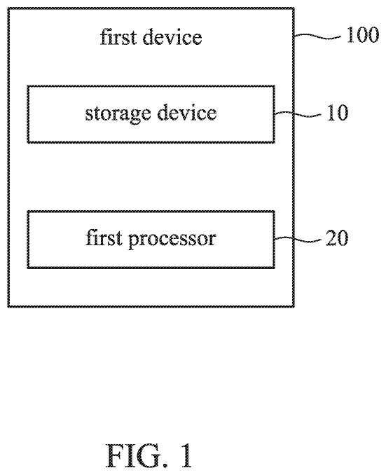

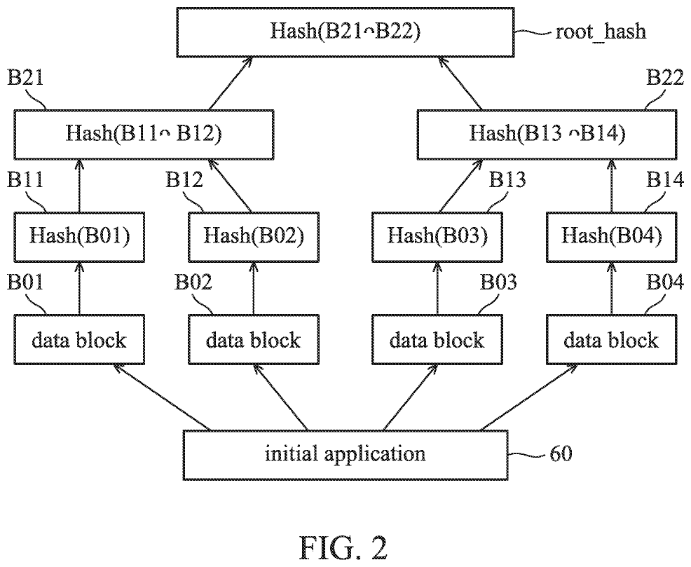

Please refer to FIGS. 1-2, FIG. 1 is a block diagram illustrating an image file packaging system according to an embodiment of the invention. FIG. 2 is a schematic diagram illustrating a verification hash tree according to an embodiment of the invention. The image file packaging system comprises a first device 100. In one embodiment, the first device 100 is a client device. In one embodiment, the first device 100 can be a computer, a tablet, a mobile phone or another electronic device with computing functions. The first device 100 is configured to receive a kernel image and a hash tree generation program. In addition, the first device 100 generates a new version kernel header, where the new version kernel header includes an initial root node. The first device 100 includes a storage device 10 and a first processor 20.

In one embodiment, the storage device 10 can be implemented by a read-only memory, a flash memory, a floppy disk, a hard disk, an optical disk, a flash disk, a magnetic tape, a database accessible via a network, or a storage medium that can be easily conceived by those of ordinary skill in the art and has the same function. The storage device 10 stores an initial application, the kernel image, the new version kernel header and the hash tree generation program.

In one embodiment, the initial application includes information, such as executable programs, libraries, settings files, keys, etc. The initial application may be an image file, such as car management, car entertainment and/or car control, etc., which can be executed by the processor in the product (for example, a network access device (NAD)). However, this is only an example. The invention is not limited thereto.

In one embodiment, the first processor 20 can be implemented by, for example, a microcontroller, a microprocessor, a digital signal processor, an application specific integrated circuit (ASIC), or a logic circuit.

In one embodiment, the first processor 20 executes a hash tree generation program. After the first processor 20 loads the hash tree generation program, the first processor 20 executes the following steps. The first processor 20 reads the initial application from the storage device 10. The hash tree generation program calculates an initial hash tree of the initial application to obtain an initial root node and embeds the initial root node into the initial kernel header to generate a new version kernel header.

For example, as shown in FIG. 2, the first processor 20 reads the initial application 60 from the storage device 10. The first processor 20 disassembles it into a data block B01-B04 every 4 Kilobyte (KB). In other words, each of the data blocks B01-B04 is a 4 KB data. A hash operation is then performed on each of the data blocks B01-B04. The data block B01 is hashed (Hash(B01)) to obtain the hash value B11. The data block B02 is hashed (Hash(B02)) to obtain the hash value B12. The data block B03 is hashed (Hash(B03)) to obtain the hash value B13. The data block B04 is hashed (Hash(B04)) to obtain the hash value B14. Next, these hash values B11 and B12 are concatenated to 4 KB and then hashed (Hash (B11∩B12), which means that the hash value B11 and the hash value B12 are concatenated and hashed to obtain a hash value B21. These hash values B13 and B14 are hashed (Hash(B13∩B14)) to obtain the hash value B22. Finally, the data blocks B21 and B22 are hashed (Hash (B21∩B22)) to get the initial root node root_hash. The algorithm of the hash operation is not limited thereto. For example, the data block B11 and the data block B12 can be added together, and then the sum is brought into the hash function (that is, the expression is expressed as: Hash (B11+) B12)). Here are examples. The part of the invention about applying hash algorithm is not limited to these examples.

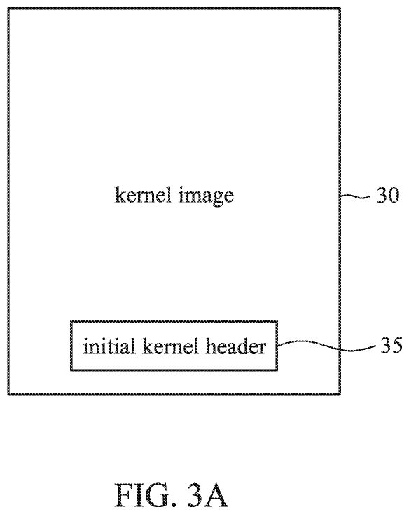

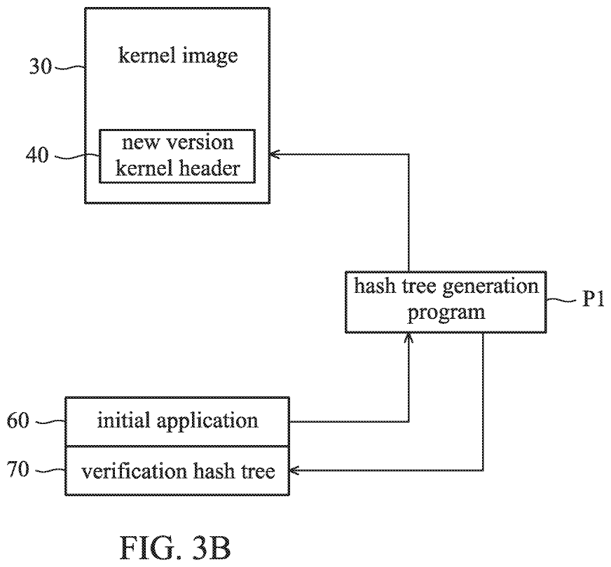

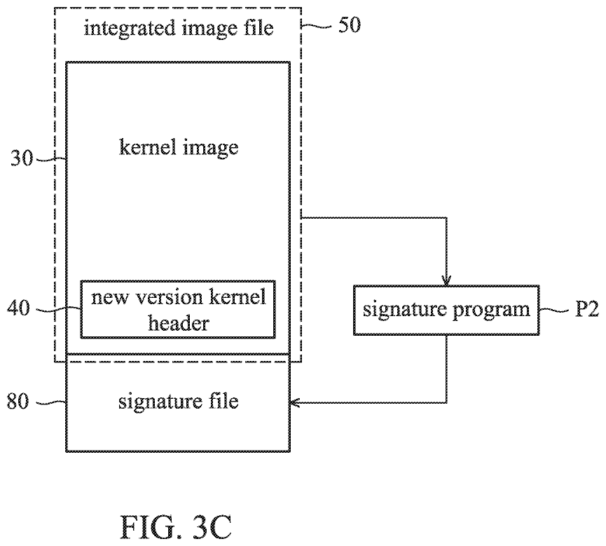

Thereby, the first processor 20 can calculate an initial hash tree of the initial application 60 by using the above method. The first processor 20 obtains an initial root node root_hash of the initial hash tree in the same manner. The first processor 20 embeds the initial root node root_hash into the initial kernel header (e.g., the initial kernel header 35 in FIG. 3A) to generate a new version kernel header 40 (e.g., new version kernel header 40 in FIG. 3B).

In one embodiment, as shown in FIG. 2, the initial root node root_hash is generated as a 32 KB data after a series of hash operations, and the initial root node root_hash has less storage space than the original data, so the amount of data comparison can be greatly reduced during verification. In addition, the size of the disassembled data block can be adjusted according to the actual design of the system, and it is not limited thereto.

Please refer to FIGS. 3A-3C, FIGS. 3A-3C are a schematic diagrams of image file packaging method according to an embodiment of the invention. In one embodiment, as shown in 3A, the kernel image 30 is generated by the processor (hereinafter referred to as the second processor) in a second device. The second device is, for example, a server of a kernel source code contractor, a computer, a tablet, a mobile phone or another electronic device with computing functions.

In one embodiment, the kernel image 30 can be produced by various computers or various electronic devices, and then placed on a server or other media for providing to a client device (such as a first device).

In one embodiment, the initial kernel header 35 is generated by the second processor. The initial kernel header 35 is used to reserve some space available to define values or add header information.

In one embodiment, the kernel image 30 includes the initial kernel header 35. The initial kernel header 35 contains an empty field for embedding the initial root node root_hash in subsequent steps.

In one embodiment, the second device firstly transmits the kernel image 30, the hash tree generation program P1, and the signature program (such as P2 in FIG. 3C) to the first device 100.

In one embodiment, in the storage device 10 of the first device 100, a hash tree generation program P1 and the signature program (such as P2 in FIG. 3C) are stored in advance.

In one embodiment, in the storage device 10 of the first device 100, a signature program (such as P2 in FIG. 3C) is stored in advance. The second device transmits the hash tree generation program P1 to the first device 100. The first device 100 then stores the hash tree generation program P1 into the storage device 10.

As shown in FIG. 3B, after the first device 100 obtains the initial application 60, the hash tree generation program P1 is executed to calculate the initial root node root_hash, and the initial root node root_hash is embedded in the initial kernel header 35 to generate the new version kernel header 40. In other words, the new version kernel header 40 contains information of the initial root node root_hash and the initial kernel header 35.

The new version kernel header 40 is embedded in front or at the back end of the kernel image 30. Kernel image 30 and new version kernel header 40 are regarded as an integrated image file 50.

In one embodiment, the first processor 20 executes the signature program P2 to obtain the signature file 80 embedded in the integrated image file 50. The signature file 80 is embedded in front or at the back of the integrated image file 50. In one embodiment, as shown in FIG. 3C, the first processor (such as the first processor 20 in FIG. 1) executes a signature program P2, and the signature program P2 regards the kernel image 30 and the new version kernel header 40 as the integrated image file 50. The integrated image file 50 is signed (e.g., using known asymmetric encryption) to obtain a signature file 80 and to embed the signature file 80 into the integrated image file 50. Therefore, in the verification step, the first processor 20 (the client's processor) or the third processor (the processor on the product) can also decrypt the signature file 80 when the integrated image file 50 is received. If decryption is successful, it means that the integrated image file 50 is normal. If the decryption fails, it means that the integrated image file 50 may be tampered with.

In one embodiment, the first processor 20 packages the integrated image file 50, the signature file 80 and the initial application 60 as a software. The first processor 20 writes the software into the third device (for example, a product). In one embodiment, the products such as driving recorders, tablets, mobile phones or other electronic devices.

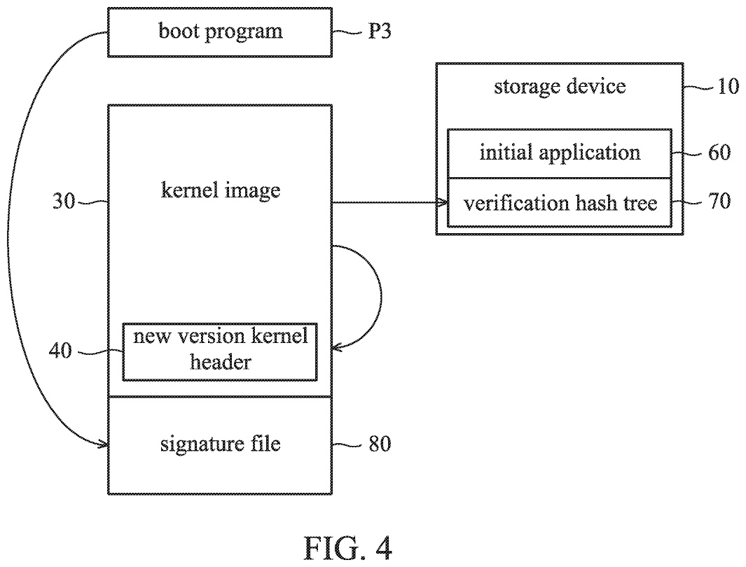

In one embodiment, as shown in FIG. 4, FIG. 4 is a schematic diagram illustrating a verification procedure according to an embodiment of the invention. The processor of the third device (hereinafter referred to as the third processor) performs verification when executing the boot program P3, for example, using the same asymmetric encryption method that generates the signature file 80 to determine whether the signature file 80 on the third device is decrypted correctly. If the decryption is successful, it means that the integrated image file 50 is normal. If the decryption fails, it means that the integrated image file 50 may be tampered with. In addition, the third processor executes the hash tree verification program (the same steps as the hash tree generation program P1), generates the verification hash tree 70 according to the initial application 60, obtains the verification root node, and then compares the verification root node with the new version kernel header 40 to make sure that the initial root node root_hash is correct. If the two are the same, the initial application 60 is correct. If the two are different, the initial application 60 is incorrect.

In one embodiment, when the first device (for example, the first device 100 in FIG. 1 is a client device) obtains or generates a new version application, the first processor 20 of the first device 100 executes the hash tree generation program P1 to calculate a new version application. A new version hash tree replaces the initial root node with a new version root node hash value of the new hash tree to produce a new version generate header.

In this way, when the client wants to update the application, the first processor 20 in the first device 100 of the client side can execute the hash tree generation program P1 to calculate a new version kernel header. The new version kernel header is added to the front or back of the kernel image 30. In addition, the first processor 20 executes the signature program P2 to treat the kernel image 30 and the new version kernel header as a new version image file, and signs the new version image file to obtain a new version signature file. A processor 20 embeds the new version signature file into the front end or the back end of the new version image file and writes the new version image file into the product, so that the image of the new product can be completed on the client side. In the process, there is no need to change to the kernel image 30 provided by the contractor. In addition, the new version kernel header can also be used in the subsequent verification process. The verification process is shown in FIG. 4 and its corresponding paragraphs, so it is not described here.

Therefore, the image file packaging method of the present invention can update the application on the client side without changing the kernel image 30 provided by the contractor, thereby greatly reducing the time cost required for the contractor to repackage the updated application to complete the entire image file. The image file packaging method also allows the client to generate a variety of full images (integrated image files) in real time.

In one embodiment, when the integrated image file 50 and the signature file 80 are generated, they can be written to a product (such as a driving recorder, tablet, mobile phone or another electronic device), and the product can verify whether the kernel image 30 in the integrated image file 50 is correct.

In one embodiment, after the client side develops the initial application 60, the client side may provide the initial application 60 to the contractor. The contractor develops the kernel image 30, the hash tree generation program P1, and the signature program P2. Next, the contractor only needs to provide the kernel image 30, the initial kernel header 35, the hash tree generation program P1, and the signature program P2 to the client device when the software is released for the first time (e.g., the first device 100, as shown in FIG. 1). In the subsequent processes, the first device 100 generates the integrated image file 50 and a signature file 80, and does not need to change the kernel image 30 provided by the contractor. In addition, the third device (e.g., the product) can apply the above method to determine whether the initial application 60 has been tampered with and/or whether the kernel image 30 is correct. Furthermore, when the first device 100 wants to update the application, the first processor 20 can execute the hash tree generation program P1 to calculate a new version kernel header and add the new version kernel header at the backend or the frontend of the kernel image 30. The first processor 20 can execute the signature program P2, treat the kernel image 30 and the new version kernel header as a new version image file, and sign the new version image file to obtain a new version signature file. The first processor 20 embeds the new version signature file into the front or back of the new version image file, and writes the new version image file into the third device, so that the product update can be completed on the client side.

In summary, the image file packaging method and the image file packaging system shown in the present invention can calculate a new core header by itself when the client device wants to update the application, and does not need to change to the core image file provided by the contractor. The new kernel headers can also be used for subsequent verification processes. In addition, it is also possible to multiple protect the full image by signing the integrated image file. Therefore, the image file packaging method of the present invention can update the application when the client does not need to change the kernel image provided by the contractor, thereby avoiding the time required for the contractor to repackage the entire image file, so that the client can better instantly generate kinds of integrated image files. The image file packaging method of the present invention also provides a mechanism to validate new applications and the integrated images file.

While the invention has been described by way of example and in terms of the preferred embodiments, it should be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An image file packaging method, applied to a first device, wherein the first device comprises a storage device and a first processor, and the image file packaging method comprises:
receiving a kernel image using the first device; wherein an initial kernel header is located in the kernel image;
storing an initial application and the kernel image in the storage device; and
using the first processor to execute a hash tree generation program, wherein the hash tree generation program performs the following steps:
calculating an initial hash tree of the initial application to obtain an initial root node; and
embedding the initial root node into the initial kernel header to generate a new version kernel header.

2. The image file packaging method of claim 1, wherein the initial kernel header is generated by a second processor of a second device.

3. The image file packaging method of claim 1, further comprising:
executing a signature program; wherein the signature program regards the kernel image and the new version kernel header as an integrated image file;
signing the integrated image file to obtain a signature file; and
embedding the signature file into the integrated image file.

4. The image file packaging method of claim 1, further comprising:
obtaining or generating a new version application; wherein the first processor executes the hash tree generation program;
calculating a new version hash tree of the new version application;
replacing the initial root node with a new version root hash value of the new version hash tree to generate a new version kernel header.

5. The image file packaging method of claim 4, wherein the first processor executes a signature program; wherein the signature program regards the kernel image and the new version kernel header as an integrated image file; the first processor signs the integrated image file to obtain a signature file and embeds the signature file into the integrated image file.

6. An image file packaging system, comprising:
a first device, configured to receive a kernel image; wherein an initial kernel header is located in the kernel image, and the first device comprises:
a storage device, configured to store an initial application and the kernel image; and
a first processor, configured to execute a hash tree generation program; wherein the hash tree generation program calculates an initial hash tree of the initial application to obtain an initial root node and embeds the initial root node into the initial kernel header to generate a new version kernel header.

7. The image file packaging system of claim 6, wherein the initial kernel header is generated by a second processor of a second device.

8. The image file packaging system of claim 6, wherein the first processor executes a signature program; wherein the signature program regards the kernel image and the new version kernel header as an integrated image file, the signature program signs the integrated image file to obtain a signature file; and the signature program embeds the signature file into the integrated image file.

9. The image file packaging system of claim 6, wherein the first device obtains or generates a new version application; wherein the first processor executes the hash tree generation program, calculates a new version hash tree of the new version application and replaces the initial root node with a new version root hash value of the new version hash tree to generate a new version kernel header.

10. The image file packaging system of claim 9, wherein the first processor executes a signature program; wherein the signature program regards the kernel image and the new version kernel header as an integrated image file; the first processor signs the integrated image file to obtain a signature file and embeds the signature file into the integrated image file.
